(19) United States
(12) Patent Application Publication
(10) Pub. No.: US 2007/0092712 A1
(43) Pub. Date: Apr. 26, 2007

(54) Articles having a moisture-resistant protective coating and methods of manufacturing such articles

(76) Inventor: Simon K. Hodson, Santa Barbara, CA (US)

Correspondence Address: John M. Guynn;WORKMAN NYDEGGER, 1000 Eagle Gate Tower, 60 East South Temple, Salt Lake City, UT, 84111, US

(21) Appl. No.: 11/257,674

(22) Filed: Oct. 25, 2005

(51) Int. Cl. B32B 3/26; B32B 9/00; H05B 6/00

(52) U.S. Cl. 428/304.4; 428/318.4; 264/454

(57) ABSTRACT

Laminated articles include a porous and/or moisture-sensitive substrate and a multi-layer laminate coating applied thereto. The substrate includes at least one polymer binder (e.g., a starch, a cellulose ether, a polysaccharide gum, a protein, paper, paperboard, or a molded pulp). The multi-layer laminate coating includes an inner layer oriented toward the substrate and an outer layer oriented away from the substrate. The inner layer comprises at least one soft thermoplastic polymer having a melting or softening temperature that is lower than the melting or softening temperature of at least one hard thermoplastic polymer within the outer layer. Heating the multi-layer laminate causes the inner layer to become softened and adhesive, allowing it to adhere to the molded substrate. The higher melting or softening temperature allows the outer layer to maintain the structural integrity of the multi-layer laminate during the coating process.

### BACKGROUND OF THE INVENTION

1. The Field of the Invention

The invention is in the field of manufacturing articles that include a porous or moisture-sensitive substrate and a moisture-resistant laminate coating thereon. The laminate coating used in the manufacturing process is a film or sheet having multiple layers that facilitate adhesion to the substrate while maintaining structural integrity of the film or sheet during processing. One or both of the substrate and laminate coating may be biodegradable (i.e., degrade when exposed to bacteria or fungus).

2. The Relevant Technology

Food and beverage containers have been manufactured out of various materials through the years. Plastics are particularly ubiquitous because they are relatively inexpensive and have other desired attributes for food and beverage packaging, such as impermeability and strength. One drawback of manufacturing food containers entirely out of plastic, however, is that most plastics are not environmentally friendly because they do not decompose but persist for many years.

An alternative to plastic that has proven to be useful in manufacturing food and beverage containers are molded starch-based containers and other molded articles products manufactured by Earthshell® Corporation, headquartered in Santa Barbara, Calif. Such starch-based articles, including but not limited to foam starch products, which are made primarily from starch, reinforcing fibers, and fillers, can be used to manufacture plates, bowls, lids, hinged sandwich containers, trays, boxes, and other food packaging products that are relatively strong and durable and environmentally friendly.

The starch-based articles can be used alone as a desired dry goods container or, alternatively, they can be coated with various coatings, in order to instill certain properties, such as protection against moisture and chemicals. Attempts have been made to apply coatings by spraying a liquid (e.g., molten wax) over the starch-based substrate surface that thereafter hardens as a solid coating. The downside of this procedure is that coating material that misses the substrate can quickly build up on the manufacturing equipment, necessitating frequent shutting down of the equipment for cleaning. The resulting overspray must typically be recycled and reconstituted.

Another coating process that was attempted involves applying a pre-formed film or sheet as a solid coating over the substrate surface. While this eliminates buildup of excess coating material due to overspray, there are problems associated with the inability of the film coating to adhere to the substrate while also maintaining its integrity as a sheet. If the sheet or film is maintained at a temperature low enough to maintain its integrity and prevent tearing or ripping during the coating process, it often fails to adhere well to the substrate. The result of insufficient adhesion is delamination of the coating from the substrate. If, on the other hand, the sheet or film is heated so as to be sufficiently sticky to adhere to the substrate, it can tear or rip during the coating process, resulting in a product that is rejected and/or necessitating an abrupt shutdown of the manufacturing process. Such is common when using PLA films, for example. Even if the sheet or film coating does not tear or rip during the coating process, the resulting coated articles can self-adhere to each other when stacked together in the event the coating has not cooled sufficiently to no longer be sticky or adhesive.

### BRIEF SUMMARY OF THE PREFERRED EMBODIMENTS

The present invention is directed to articles that include a porous and/or moisture-sensitive substrate and a multi-layer laminate coating thereon and methods for manufacturing such articles. The substrate may be a porous or non-porous molded article that includes a moisture-sensitive polymer binder, a paper or paperboard sheet or article fashioned therefrom, or a molded pulp. The laminate coating includes multiple layers to facilitate adhesion to the substrate while maintaining structural integrity of the sheet during the coating process.

According to one embodiment, the porous and/or moisture-sensitive substrate is biodegradable (i.e., is structurally and/or molecularly broken down by biological means in the presence of, or through the action of, bacteria or fungus) and/or water-degradable (i.e., at least partially dissolves, degrades or otherwise breaks down when exposed to water over either a short or prolonged period of time). The substrate may include, for example, a biodegradable and/or moisture-sensitive binder such as starch, cellulose ether, polysaccharide, protein, or other moisture-sensitive polymer binder, as well as other ecologically compatible materials, such as natural plant-based fibers and/or natural mineral particulate fillers such as ground limestone. In one embodiment, the substrate is a highly water-degradable and biodegradable molded foamed starch material reinforced with fibers and filled with an inorganic particulate filler. In another embodiment, the substrate comprises paper, paperboard or a molded pulp.

According to one embodiment, the multi-layer laminate coating is biodegradable and is made from biodegradable polymers, optionally filled with plant-based fibers for reinforcement and/or natural mineral particulate fillers. Alternatively, one or both layers may comprise nonbiodegradable polymers.

The multi-layer laminate coating is designed to reliably adhere to the porous and/or moisture-sensitive substrate while also maintaining its integrity as a sheet or film during the coating process and resisting self-adhesion of the coated articles when stacked together. To accomplish this, the multi-layer laminate coating comprises a plurality of layers or regions (e.g., two) formed from different polymers having different properties that are co-extruded or otherwise layered to form a layered laminate film or sheet. The layered sheet or film coating includes a first, or outer, layer formed of a higher melting or softening point polymer and a second, or inner, layer formed of a lower melting or softening point polymer. The higher melting or softening point polymer shall be referred to as a “hard” polymer, and the lower melting or softening point polymer shall be referred to as a “soft” polymer.

Examples of “hard” biodegradable polymers include, but are not limited to, modified polyethylene terephthalates, such as BIOMAX manufactured by Du Pont, polylactic acid (PLA), higher melting polyesteramides, such as BAK 2195 manufactured by Bayer, PLA/PGA/PCL terpolymers, such as H100J manufactured by Mitsui Chemicals, and higher melting grades of PHBV or PHB, e.g., manufactured by Monsanto Co. Non-biodegradable “hard” polymers include higher melting polyolefines and polystyrene.

Examples of “soft” biodegradable polymers include branched aliphatic-aromatic copolyesters, such as ECOFLEX manufactured by BASF, and linear aliphatic-aromatic copolyesters, such as EASTARBIO manufactured by Eastman Chemical. ECOFLEX is greatly preferred over EASTARBIO because of its superior moisture resistance. EASTARBIO is much more prone to absorb moisture from the air, which can result in undesirable shortening of the polymer chain as a result of heat induced hydrolysis, deleteriously affecting the materials properties of the polymer. When used, EASTARBIO is advantageously pre-dried to prevent heat-induced hydrolysis and chain shortening. Other “soft” biopolymers include, but are not limited to, polycaprolactone (PCL), such as TONE manufactured by Union Carbide, lower melting polyesteramides, such as BAK 1095 manufactured by Bayer, aliphatic polyesters, such as BIONELLE 1001, BIONELLE 3001, and BIONELLE 6000 manufactured by Showa High Polymer, Ltd, and lower melting polyester carbonates. Non-biodegradable “soft” polymers include lower melting polyolefines.

During the coating process, the inner layer of the multi-layer laminate coating is oriented toward the substrate and the outer layer away from the substrate. The laminate coating is warmed or heated prior to or during the coating process. Because the soft polymer of the inner layer softens or melts at a lower temperature than the hard polymer of the outer layer, heating the layered laminate coating causes the inner layer to at least partially soften or melt in order to become sufficiently sticky to adhere to the substrate. Conversely, because the hard polymer of the outer layer softens or melts at a higher temperature than the soft polymer of the inner layer, the outer layer of the heated multi-layer laminate coating remains sufficiently unmelted, unsoftened and strong to prevent ripping or tearing of the film or sheet coating during the coating process. The outer layer also remains sufficiently non-adhesive to prevent the coated articles from adhering together when stacked.

According to a preferred embodiment, the laminate coating is uniformly heated to ensure more uniform adhesion between the coating and substrate. Heating the laminate coating unevenly (e.g., by using air that is heated unevenly or that impacts the laminate sheet or film unevenly) results in an article that has regions of stronger and weaker bonding between the laminate coating and substrate. To ensure a good bond throughout, the laminate coating may, in such cases, require heating to a higher temperature to ensure the inner layer becomes sufficiently soft and adhesive throughout. Overheating is wasteful, uneconomical, and may cause oversoftening of the outer layer of the multi-layer laminate film or sheet, thereby exceeding the processing window that overwise exists when the inner layer is heated uniformly.

In addition to having a higher melt or softening temperature, the outer layer typically has higher moisture barrier properties than the inner layer, including a lower moisture vapor transfer rate (“MVTR”). In the case where the substrate either absorbs or desorbs moisture from or into the atmosphere, the laminate coating may advantageously help maintain the proper moisture balance, which helps avoid variations in quality and performance (e.g., lower durability) within the manufactured articles. The outer layer, or optionally, even one or more additional layers, may be selected to provide a barrier to gases, improve microwaveability, or provide other desired properties.

Once the laminate coating has been applied, excess material is trimmed from the article. In order to trim away excess coating material (e.g., where an oversized square or continuous sheet is applied to a round substrate), a localized area of increased heat can be applied to the perimeter of the coated article in order to melt both the inner and outer layers of the sheet coating at the perimeter. This allows excess coating to be melt-trimmed from the substrate without significantly softening the outer coating layer. The localized area of increased heat can be supplied by heated air or a heated cutting apparatus. It is preferable for the heat to be applied uniformly in order to ensure a clean break throughout the article. Heat-trimming unevenly can yield coated articles having a ragged edge.

The substrate to which the laminate coating is applied may comprise any biodegradable container or article known in the art. According to one embodiment, the molded substrate includes starch as the primary or sole binder. Other exemplary natural binders include cellulose ethers, proteins and polysaccharide gums. In order for the molded article to be lightweight, it can be foamed (i.e., by incorporating a substantial quantity of void spaces). One way is to heat an aqueous composition within a mold, with the evaporating water acting as a foaming or expansion agent. The moisture-resistant coating materials of the invention are particularly useful in the case of foamed substrates made of water-sensitive polymers since they are more prone to water degradation than non-foamed substrates, all things being equal.

In the case of starch-based substrates, the starch binder can include any type of starch, e.g., potato starch, corn starch, waxy corn starch, rice starch, wheat starch, tapioca starch, their grain predecessors (e.g., flour or cracked grain) or their modified counterparts. Presently preferred starches are corn starch, tapioca starch, and wheat starch because of their ability to provide improved strength, durability, and greater consistency of quality within the molded articles. Molded substrates made using potato starch as the sole binder have lower and less consistent porosity. Replacing some or all of the potato starch with another type of starch has been found to yield molded substrates having higher and more consistent porosity, as well as higher surface modulus and better cut resistance. Providing a substrate having higher and more consistent porosity significantly increases the bond strength and consistency of the bond between the substrate and the laminate coating.

Molded substrates may include other components that provide desired properties, including but not limited to, fibrous materials (i.e., reinforcing fibers and particulate fibrous fillers), inorganic particulate fillers, mold release agents, humectants, secondary binders, and internal sealants.

An exemplary method for manufacturing coated articles according to the invention includes: (1) forming a molded porous and/or moisture-sensitive substrate, such as by heating an aqueous composition, batter or dough in a heated mold cavity to remove water by evaporation and solidify the binder; (2) heating, such as using heated air or radio-frequency energy, a multi-layer laminate sheet or film having inner and outer layers to a temperature sufficient to soften the inner layer and render it adhesive to the substrate, but not so high as to soften the outer layer to the point that it will break and/or be adhesive; (3) attaching the heated laminate sheet or film to a surface of the molded article, such as by vacuum-assisted lamination and/or pressing in order for the softened and adhesive inner layer to adhere to the article surface; (4) and trimming excess laminate coating material, such as by using heat to melt the laminate sheet near an outer edge of the molded substrate. In the case where the substrate is substantially cooler than the laminate coating, contacting the laminate coating the substrate causes sudden cooling (or “quenching”) of the soft polymer of the inner layer, thereby causing almost immediately solidification and adhesion of the soft polymer to the substrate.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a flow chart that illustrates an exemplary coating process according to the invention for applying a multi-layer laminate coating to a molded substrate;

FIG. 2 is a cross sectional view of an exemplary apparatus for attaching a multi-layer laminate coating to a molded substrate, the apparatus including a suction member, a forming cavity, heating means for heating air, blowing means for blowing air, diffusing means for providing substantially uniform heated air velocity, and control means for regulating the flow of the heated air;

FIG. 3 shows the apparatus of FIG. 2 in which a molded substrate attached to the suction member is positioned against an inner surface of a multi-layer laminate film or sheet coating;

FIG. 4 shows the apparatus of FIG. 2 in which the multi-layer laminate sheet is shown being trimmed at the substrate edge by hot air forced through a gap between the substrate and a wall of the coating apparatus; and

FIG. 5 is a cross sectional view of an exemplary multi-layer laminate-coated molded article of manufacture including a molded substrate and a multi-layer laminate coating having inner and outer layers applied to a surface of the article.

### DETAILED DESCRIPTION OF THE PREFERRED EMBODIMENTS

### I. Introduction and Definitions

The terms “molded article”, “molded substrate” and “substrate”, as used herein, refer to porous and/or moisture-sensitive substrates that include a moisture-sensitive polymer binder, a paper or paperboard sheet, or a molded pulp. The substrate may be porous or non-porous. Additional components (e.g., one or more fiber and/or particulate fillers) may also be included. The molded substrates may be in the shape of various containers, e.g., plates, bowls, lids, trays, boxes, platters, and beverage containers. Although the molded substrates may be shaped as food packaging and beverage containers, the terms “molded article”, “molded substrate” and “substrate” may also apply to articles that are not used for food packaging.

The term “multi-layer laminate”, as used herein, refers to a thin sheet or coating formed of two or more different thermoplastic polymer materials to facilitate adhesion to the substrate while maintaining structural integrity of the sheet during the coating process. The multi-layered laminate coating is designed to reliably adhere to the porous and/or moisture-sensitive substrate while also maintaining its integrity as a sheet or film during the coating process and resisting self-adhesion of the coated articles when stacked together. To accomplish this, the multi-layer laminate includes at least two different layers of different materials having different properties that are co-extruded or otherwise layered to form a multi-layer laminate film or sheet. The multi-layer laminate includes a first, or outer, layer formed of a higher melting or softening point polymer (i.e., a hard polymer) and a second, or inner, layer formed of a lower melting or softening point polymer (i.e., a soft polymer). The thickness and material composition of the inner and outer layers of the laminate sheet may be varied, for example, to provide different attributes to the manufactured article, such as moisture resistance, strength and flexibility. The outer layer or additional layers may be configured to provide a barrier to gases, improve microwaveability, or provide other desired properties.

The terms “laminate article”, “laminated article” and “laminated substrate” shall refer to coated articles according to the invention that include a porous and/or moisture-sensitive molded substrate and a moisture-resistant multi-layered laminate film or sheet coating on at least a portion of the molded substrate. The coating is typically configured to improve the moisture resistance of the laminated article, although other types of protection in addition to or instead of moisture resistance may be possible.

During the coating process, the inner layer of the multi-layer laminate coating is oriented toward the substrate and the outer layer away from the substrate. Because the soft polymer of the inner layer softens or melts at a lower temperature than the hard polymer of the outer layer, heating the layered laminate coating causes the inner layer to at least partially soften or melt in order to become sufficiently sticky to adhere to the substrate. Because the hard polymer of the outer layer softens or melts at a higher temperature than the inner layer, the outer layer of the heated multi-layer laminate remains sufficiently unmelted, unsoftened, and strong to prevent ripping or tearing of the film or sheet coating during the coating process. In addition, the outer layer also remains sufficiently non-adhesive to prevent the coated articles from adhering together when stacked.

### II. Molded Articles and Substrates

The present invention contemplates applying a multi-layer laminate coating material to a porous and/or moisture sensitive molded article substrate. The molded articles are typically coated in order to improve moisture resistance, although coatings may provide other types of protection in addition to, or instead of, moisture resistance. Molded articles that may be used according to the present invention include, but are not limited to, a structural matrix held together by one or more moisture sensitive polymer binders, paper, paperboard, or molded pulp. Examples of moisture-sensitive polymer binders include starches, cellulose ethers, proteins, and polysaccharide gums. The substrate may also include other components including, but not limited to, natural plant-based fibrous materials, including reinforcing fibers and fibrous particulates, inorganic particulate fillers (e.g., ground limestone), organic particulate fillers, biodegradable synthetic polymers, water-resistant materials, thickening agents, mold release agents, humectants, colorants, anti-spoilage agents, and strengthening filaments.

According to the currently preferred embodiments, the molded substrates are molded from aqueous compositions that include water, a water-dispersible organic polymer binder, and optionally other components (e.g., natural plant-based fibers and/or natural mineral particulate fillers such as ground limestone) as desired to yield molded articles or substrates having desired properties. The polymer binder is preferably biodegradable and/or water-degradable.

To impart strength, toughness, and fracture resistance to the substrate, reinforcement fibers having an aspect ratio of at least about 10:1 may be used. Reinforcement fibers will preferably have an aspect ratio of at least about 25:1, more preferably greater than about 100:1, and most preferably greater than about 250:1. Any known plant fibers can be used as reinforcement fibers. Such fibers are different from fibrous particulates, such as saw dust or bran, which are added mainly as a passive filler rather than to impart strength.

To reduce material costs and also improve the ability of the molded compositions to release water by evaporation, a variety of inorganic and/or organic fillers may be included. Examples of natural inorganic mineral fillers include calcium carbonate, ground limestone, silica, clay, talc, and ground rock.

A mold release agent may be included in order to prevent unwanted adhesion of the molded article substrate to the mold apparatus. Examples include magnesium stearate, vegetable oils, fatty acids and salts of fatty acids desired from vegetable or animal oils, minerals oils, paraffin and wax.

The aqueous composition is typically introduced into a mold, formed into a desired shape of the molded article substrate, and heated in order to remove at least a portion of the water by evaporation and thereby solidify the binder. Examples of a wide variety of molded containers and other articles, as well as compositions, methods and manufacturing apparatus that used to the molded articles or substrates are disclosed in the following U.S. Pat. Nos. 5,545,450; 5,580,624; 5,618,341; 5,658,603; 5,660,900; 5,662,731; 5,679,145; 5,683,772; 5,691,014; 5,702,787; 5,705,239; 5,705,242; 5,709,827; 5,753,308; 5,783,126; 5,830,305; 5,868,824; 6,030,673; 6,090,195. For purposes of disclosing molded containers and other articles that may be used in the present invention, as well as compositions, methods and apparatus for their manufacture, the foregoing patents are incorporated by reference.

According to one currently preferred embodiment, the molded articles will include starch as the predominant or sole binder. Examples of useful starch binders include potato starch, corn starch, waxy corn starch, rice starch, wheat starch, tapioca starch, their grain predecessors (e.g., flour or cracked grain), and their modified counterparts. Corn starch, tapioca starch, and wheat starch have been found to be especially useful and are currently preferred because of their ability to provide improved strength, durability, and more consistent quality within the manufactured article. Potato starch can be used, particularly when blended with one or more other types of starch. Molded substrates made using potato starch as the sole binder have lower and less consistent porosity. Replacing some or all of the potato starch with another type of starch yields molded substrates having higher and more consistent porosity, higher surface modulus, and better cut resistance. The higher and/or more consistent porosity significantly increases bond strength and consistency of the bond between the substrate and the multi-layer laminate. In addition, it has been found that replacing at least some of the potato starch with another type of starch reduces the amount of mold release agent (e.g., magnesium stearate) that is needed for good mold separation.

According to one embodiment, molded starch-based substrates are non-foamed and comprise fibers bound together by the starch binder. In another embodiment, molded starch-based substrates are foamed and include a gaseous phase comprising voids dispersed throughout the structural matrix. Foaming the structural matrix has the effect or reducing material costs and also the weight of the molded articles.

Molded foam starch substrates are manufactured from aqueous compositions comprising at least water and ungelatinized starch granules. Other components, such as reinforcing fibers, a thickening agent that helps disperse the fibers throughout the aqueous compositions during mixing, fillers, mold release agents, and other additives may also be present. Including ungelatinized starch granules initially is advantageous because it greatly reduces the viscosity of the molding mixture. This, in turn, greatly reduces the energy costs of the molding process since less water is required to produce a molding mixture having a desired viscosity, all things being equal.

When the aqueous starch-based composition is heated within a mold, the heated water causes the initially ungelatinized starch granules to become at least partially gelatinized. Further heating causes the water to act as a foaming or expansion agent within the starch composition within the mold. The use of a mold apparatus having vent holes assists in the expansion process whereby the heated molding mixture fills the mold cavity. Further heating drives off a substantial portion of the water by evaporation, thereby allowing or causing the starch binder to solidify. Upon demolding the article, flashing attached to the molded foam starch substrate can be removed.

### III. Multi-Layer Laminate Coatings

The multi-layer laminate sheet or film coating includes a plurality of layers (e.g., two, an inner layer and an outer layer) having different properties that are co-extruded or otherwise layered to form a layered laminate sheet or film. In general, the soft inner layer (that layer which is to contact and bond to the substrate) will have a melting point or softening range below that of the hard outer layer. The actual melting point or softening range of the inner and outer layers, as well as the difference between, is at least partially dependent on the temperature to which the multi-layer laminate film or coating is heated and/or the length of time it is maintained at the maximum temperature.

In general, the melting or softening temperature of at least one polymer included in the inner layer that will come into contact with the molded article or substrate will be sufficiently low relative to the coating temperature so that it will be sufficiently sticky to adhere to a surface of the molded article against which it is placed. Conversely, the melting point or softening range of at least one polymer used in making the outer layer of the laminate coating will be sufficiently high relative to the coating temperature so that it will be sufficiently firm and non-sticky so that it will maintain the strength and integrity of the film or sheet coating sufficient to complete the coating process. One of skill in the art, using the concepts disclosed herein, will be able to select polymers that meet the above criteria.

In order to provide desired adhesive properties, the melting or average softening temperature of at least one soft polymer included in the inner layer will preferably be at least about 1° C. below the maximum temperature to which the inner layer is heated during the coating process, more preferably at least about 5° C. below the maximum temperature to which the inner layer is heated during the coating process, and most preferably at least about 10° C. below the maximum temperature to which the inner layer is heated during the coating process.

Conversely, the melting or softening temperature of at least one hard polymer included in the outer layer will preferably be at least about 5° C. above the maximum temperature to which the outer layer is heated during the coating process, more preferably at least about 15° C. above the maximum temperature to which the outer layer is heated during the coating process, and most preferably at least about 30° C. above the maximum temperature to which the outer layer is heated during the coating process.

In order to provide an adequate processing window (i.e., temperature range) between the lower temperature at which the inner layer becomes sufficiently soft and adhesive and the upper temperature at which the outer layer becomes unduly soft and/or adhesive, the at least one hard polymer of the outer layer of the laminated sheet or film has a melting or softening temperature that is at least about 10° C. greater than the melting or softening temperature of the at least one soft polymer of the inner layer, more preferably at least about 20° C. greater, and most preferably at least about 50° C. greater than the melting or softening temperature of the of the at least one soft polymer of the inner layer.

In general, it will be preferable for the inner layer to include at least one soft thermoplastic polymer having a melting or softening temperature less than about 140° C., more preferably less than about 130° C., and most preferably less than about 120° C. Conversely, it will be preferable for the outer layer to include at least one hard thermoplastic polymer having a melting or softening temperature greater than about 150° C., more preferably greater than about 160° C., and most preferably greater than about 170° C.

The soft polymer may be biodegradable. Examples of suitable soft biodegradable polymers that have been found to be useful as the primary or sole soft polymer within the inner layer of a multi-layer laminate film or sheet coating include, but are not limited to, aliphatic-aromatic copolyesters (such as those manufactured by BASF and Eastman Chemical), aliphatic polyesters which include repeating units having at least 5 carbon atoms, e.g., polyhydroxyvalerate, polyhydroxybutyrate-hydroxyvalerate copolymer and polycaprolactone (such as those manufactured by Daicel Chemical, Monsanto, Solvay, and Union Carbide), and succinate-based aliphatic polymers, e.g., polybutylene succinate (PBS), polybutylene succinate adipate (PBSA), and polyethylene succinate (PES) (such as those manufactured by Showa High Polymer).

The foregoing polymers are described in greater detail in U.S. Pat. No. 6,573,340, which describes their use as the “soft” biopolymer component within substantially homogenous blends comprising stiff and soft biodegradable polymers. They are characterized as “soft” biopolymers because they have a glass transition temperature that is less than about 0° C.

The hard polymer may be biodegradable. Examples of suitable biodegradable polymers that have been found to be useful as the primary or sole hard polymer within the outer layer of a multi-layer laminate film or sheet coating include, but are not limited to, modified polyethylene terephthalates (such as those manufactured by DuPont), polyesteramides (such as those manufactured by Bayer), polylactic acid-based polymers (such as those manufactured by Cargill-Dow Polymers and Dianippon Ink), terpolymers based on polylactic acid, polyglycolic acid and polycaprolactone (such as those manufactured by Mitsui Chemicals), polyalkylene carbonates (such as polyethylene carbonate manufactured by PAC Polymers), and polyhydroxybutyrate. The foregoing polymers are also described in greater detail in U.S. Pat. No. 6,573,340, which describes their use as the “stiff” (or hard) biopolymer component within substantially homogenous blends comprising stiff and soft biodegradable polymers. They are characterized as “stiff” (or hard) biopolymers because they have a glass transition temperature greater than about 10° C. For purposes of generally disclosing useful biopolymers that may be used to manufacture multi-layer laminate film or sheet coatings according to the invention, U.S. Pat. No. 6,573,340 is incorporated herein by reference.

Whereas U.S. Pat. No. 6,573,340 discloses useful blends comprising stiff and soft polymers based on their respective glass transition temperatures, it has now been found that forming a multi-layer laminate from two or more thermoplastic polymers having different melting or softening temperatures yields multi-layer sheets and films that are more useful in coating molded substrates compared to homogeneous blends of stiff and soft polymers. Indeed, there may only be a loose correlation between the glass transition temperature of a given polymer and its melting or softening temperature. As such, it is possible that one or more of the “soft” biopolymers disclosed in U.S. Pat. No. 6,573,340 may be useful in making the hard outer layer of a multi-layer laminate coating, and one or more of the “stiff” biopolymers disclosed in U.S. Pat. No. 6,573,340 may be useful in making the soft inner layer of a multi-layer laminate coating. The relevant relationship is the difference between melting or softening temperature of a particular polymer and the coating temperature, not the glass transition temperature and the coating temperature.

According to one currently preferred embodiment, at least a portion of the hard outer layer of the multi-layer laminate film or sheet coating comprises one or more of BIOMAX, a modified polyethylene terephthalate (mod-PET) sold by DuPont, or polylactic acid (PLA), both of which have been found to be at least partially biodegradable (i.e., they are structurally and/or molecularly broken down by biological means in the presence of, or through the action of bacteria or fungus). Both BIOMAX and PLA are useful because of their relatively high melting points or softening temperatures. The melting or softening temperature of some grades of BIOMAX reportedly range from about 150-200° C., and the melting or softening temperature of reportedly ranges from about 135-180° C. PLA 4042D, one grade of PLA available from Cargill-Dow Polymers, has a melting temperature of 135° C. Some grades of BIOMAX (e.g., BIOMAX 6926) reportedly have a melting point of 200-208° C.

BAK 2195, a polyesteramide manufactured by Bayer, reportedly has a melting point of about 175° C. H100J, a PLA/PGA/PCL terpolymer manufactured by Mitsui Chemicals, reportedly has a melting point of about 173° C. One grade of PHBV manufactured by Monsanto Co, reportedly has a melting point of 170° C.

According to one currently preferred embodiment, at least a portion of the soft inner layer of the multi-layer laminate film or sheet coating comprises one or more of ECOFLEX, an aliphatic-aromatic copolyester sold by BASF, or EASTARBIO, an aliphatic-aromatic copolyester sold by Eastman Chemical, both of which have been found to be biodegradable. Both ECOFLEX and EASTARBIO are useful because of their relatively low melting or softening temperatures. The melting or softening temperature of ECOFLEX is reportedly about 110-115° C. or 110-120° C. depending on the specific grade, and the melting or softening temperature of EASTARBIO is reportedly about 108° C. A substantial difference between ECOFLEX polymers of BASF and EASTARBIO polymers of Eastman is that ECOFLEX is branched, while EASTARBIO is linear. ECOFLEX is greatly preferred over EASTARBIO because of its superior moisture resistance. EASTARBIO is more prone to absorb moisture from surrounding air, which can lead to heat induced hydrolysis of the linear polymer chain structure. Heat induced hydrolysis or “chain shortening” negatively affects the material properties of the polymer.

The melting point of TONE, a polycaprolactone (PCL) manufactured by Union Carbide, is reportedly about 60° C. BAK 1095, a polyesteramide manufactured by Bayer, reportedly has a melting point about 125° C. BIONELLE 1001, BIONELLE 3001, and BIONELLE 6000, all manufactured by Showa High Polymer, Ltd., reportedly have melting points of 114° C., 95° C. and 102° C., respectively. A polyester carbonate manufactured by Mitsubishi Gas Chemicals, reportedly has a melting point of 110° C.

While both ECOFLEX and EASTARBIO comprise useful polymers for use in making the inner layer of the laminate coating, ECOFLEX is greatly preferred due to its superior moisture resistance. EASTARBIO, on the other hand, is more prone to absorb moisture from the air. As a result, heating EASTARBIO either during formation of the multi-layer laminate or during the coating process can result in unwanted shortening of the polymer chain as a result of heat induced hydrolysis of the ester linkage. This, in turn, can deleteriously affect the material properties of the polymer. It may therefore be desirable to pre-dry EASTARBIO prior to any heating in order to preserve polymer chain length and the desired material properties. The differences in performance may be due to the fact that ECOFLEX is more branched and EASTARBIO is more linear.

The multi-layer laminate film or sheet coatings may be manufactured using any known film or sheet forming apparatus. The individual layers may be formed independently and then stacked together, or they may be formed at the same time. According to one currently preferred embodiment, a multi-layer laminate film or sheet coating is formed by co-extruding two or more different polymers having different melting or softening temperatures to form inner and outer layers. The co-extrusion process may be carried out using film blowing or sheet casting equipment known in the art.

It may be desirable, depending on the intended use of the coated article or substrate, for one of the layers of the multi-layer laminate coating, e.g., the outer layer, to have better moisture barrier properties relative to another of the layers, e.g., the inner layer (i.e., the moisture vapor transfer rate of the outer layer may be lower than that of the inner layer).

While the thermoplastic polymers used to make the multi-layer laminate film or sheet coatings are preferably synthetic biodegradable polyesters, polyester amides, or polyester urethanes, it is within the scope of the invention to use non-biodegradable polymers (e.g., polyolefines, polystyrene). It is also within the scope of the invention to also include a variety of natural polymers and their derivatives, such as polymers and derivatives derived from starch, cellulose, other polysaccharides and proteins. It is also within the scope of the present invention to incorporate fillers and/or other additives within the inner and/or outer layers in order to lower the cost or modify the properties (e.g., modulus of elasticity or moisture vapor transfer rate) of the layers. For example, many ECOFLEX grades already include various fillers and/or additives. ECOFLEX AB-1 includes 60% talc filler, ECOFLEX AB-3 includes 40% CaCO₃ filler, ECOFLEX SL-2 includes 5% wax which can reduce the moisture vapor transfer rate, and ECOFLEX SL-1 includes 5% talc filler and 10% Erucamide as a slip agent. In addition, a wide variety of plasticizers may be used in order to impart desired softening and elongation properties.

### IV. Exemplary Methods and Apparatus for Manufacturing Laminated Articles

It is within the scope of the invention to manufacture laminated molded articles using any known or desired method or apparatus for applying a film or sheet coating to a molded article or substrate. The only stipulation is that the inner layer of the multi-layer laminate coating is advantageously heated to a temperature so as to become softened to the point of being able to adhere to a molded article or substrate to which the laminate coating is to be attached, and the outer layer is heated to a temperature that allows it to maintain sufficient strength and integrity to complete the coating process.

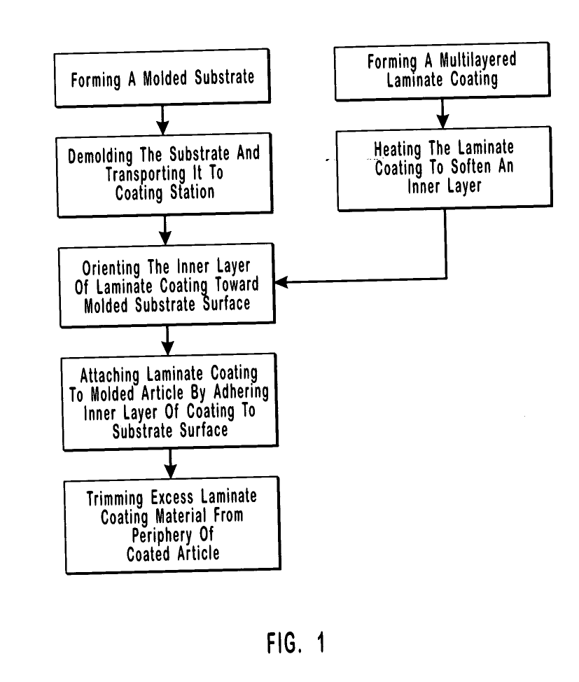

An exemplary general method for manufacturing laminated articles according to the invention is illustrated in FIG. 1. The first general process steps, which may be performed simultaneously or at different times, include forming the molded substrate and the multi-layer laminate coating. Exemplary processes for each are described above and claimed below. The molded substrate is removed from the mold and transported to a coating station or module. The multi-layer laminate coating is heated, either prior to or upon arriving at the coating station, to a temperature in order for the inner layer to become adhesive. The multi-layer laminate coating is oriented so that the inner layer faces the surface of the molded substrate to which it will be attached.

Thereafter, the multi-layer laminate coating is attached to the molded substrate by adhesion of the inner layer to a surface of the molded substrate. This may be performed in any desired way. One way involves vacuum forming, or suctioning of the laminate coating to the molded article, by providing suction or vacuum through the body of the molded article. Molded articles having some level of porosity work better for this process. Suctioning the laminate coating to the substrate surface may advantageously drawing molten or softened material from the inner layer at least partially into pores of the substrate surface, thereby creating a stronger bond thereto.

The multi-layer laminate may be pressed against the molded substrate as an alternative or in addition to vacuum-assisted lamination. Pressing the laminate coating against the substrate surface may also result in molten or softened material of the inner layer at least partially entering into pores of the substrate surface, creating a strong bond thereto.

After the multi-layer laminate coating has been adhered to the substrate surface, excess laminate coating material is trimmed from around the periphery or perimeter of the coated article. This is advantageously accomplished by heating the laminate coating in the vicinity of the article perimeter (e.g., by heated air or a solid trimming apparatus).

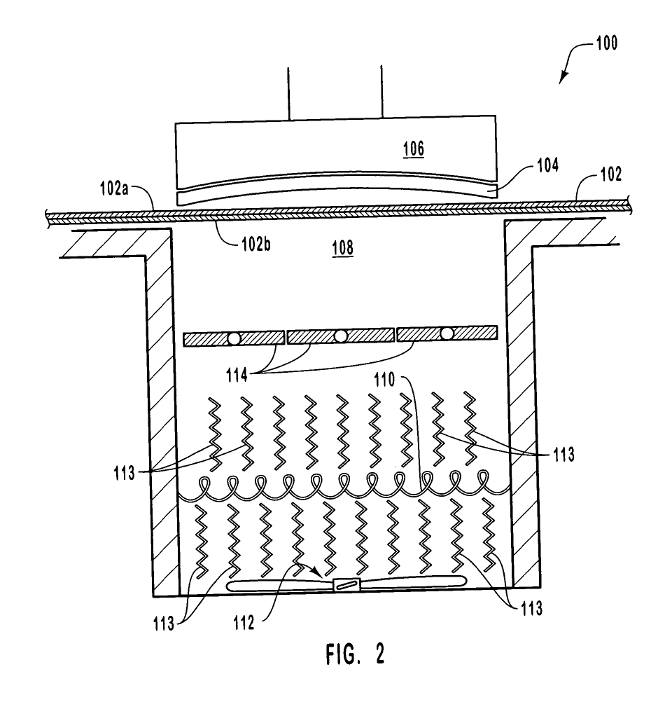

An exemplary coating apparatus 100 used to attach a multi-layer laminate film or sheet coating to a molded substrate is illustrated in FIGS. 2-4. As shown in FIG. 2, coating apparatus 100 includes a suction member 106 for applying a vacuum or suction through a substrate 104 positioned adjacent thereto in order to hold the substrate in place adjacent to a multi-layer laminate film or sheet coating 102 during the coating process. A heating cavity 108 is disposed adjacent to the hard outer layer 102b, which includes a heating element 110 disposed therein for heating air, a fan 112 for propelling heated air, diffusers 113 for providing substantially uniform heating of the air and for providing substantially uniform flow of heated air towards laminate coating 102, and louvers 114 for controlling the flow of heated air through the heating cavity 108. The heating cavity 108 is used to controllably direct heated air toward the laminate coating 102.

Diffusers 113 provide for more uniform heating of the air, for more uniform flow of heated air to heat the multi-layer laminate. Suitable commercially available diffusers using air mufflers standard in the art of pneumatic valves will be apparent to those skilled in the art. Uniformity of air heating and uniformity of air flow provide uniform heating to the multi-layer laminate, which provides more uniform softening or oz a melting and adhesion of the soft inner layer to the substrate. Such uniformity further lowers the processing temperature necessary to ensure substantially complete adhesion of the multi-layer laminate to the substrate, thereby widening the processing window (i.e., there is a wider range of temperatures at which the soft inner layer melts or softens but the hard outer layer remains strong and intact). This can be particularly important in creating an integral bond between the multi-layer laminate and the substrate, such an integral bond is characterized by a strong bond between the multi-layer laminate and the substrate such that bond strength is greater than the internal cohesion of the film and the internal cohesion of the substrate. In other words, the laminated article will tend not to break at the bond interface between the multi-layer laminate and the substrate.

As shown in FIG. 2, the laminate coating 102 includes an inner layer 102a oriented toward a surface of the molded substrate 104 and an outer layer 102b oriented away from the molded substrate 104. The laminate sheet 102 may be drawn over heating cavity 108 by any suitable means, including, but not limited to a carriage on a track, a robotic arm, or by hand. The thickness of multi-layer laminate sheet 102 illustrated in FIGS. 2-4 is exaggerated in order to more clearly illustrate the inner layer 102a and outer layer 102b.

According to one embodiment, the laminate coating 102 is preheated using RF energy or a heating element (not shown) in order to soften the inner layer 102a prior to or after positioning the laminate coating 102 adjacent to the substrate 104. According to another embodiment, the laminate coating 102 is at least partially heated by the heating cavity 108. In order to control the flow of heated air, louvers 114 can be opened or closed an appropriate amount.

According to the embodiment shown in FIG. 2, the louvers 114 are initially in a closed position in order to allow only a portion of heat produced by heating element 110 to flow toward the laminate sheet 102 (i.e., through spaces between the louvers 114 themselves and between the louvers 114 and the wall defining the heating cavity 108. This amount of heat may be sufficient to heat or maintain the laminate sheet 102 at a temperature at which the inner layer 102a becomes adhesive while the outer layer 102b maintains sufficient integrity of laminate sheet or film 102 to complete the coating process. To facilitate maintaining the proper temperature of air moving toward the laminate sheet 102 through the heating cavity 108, either or both of heating element 110 and fan 112 can be periodically activated or deactivated as desired or necessary. The diffusers 113 may alternatively or additionally be located between the louvers 114 and the laminate sheet 102 so as to provide more uniform heating and flow of the heated air.

The inner layer 102a of the multi-layer laminate sheet or film 102 is preferably heated to a temperature that is at least about 1° C. greater than the melting or softening temperature of the at least one soft polymer used the make the inner layer, more preferably at least about 5° C. greater than the melting or softening temperature, and most preferably at least about 10° C. greater than the melting or softening temperature of the of the at least one soft polymer used the make the inner layer 102a.

Similarly, the outer layer 102b of the laminated sheet or film 102 is preferably heated to a temperature that is at least about 5° C. less than the melting or softening temperature of at least one hard polymer used the make the outer layer, more preferably at least about 15° C. less than the melting or softening temperature, and most preferably at least about 30° C. less than the melting or softening temperature of the of the at least one hard polymer used the make the outer layer 102b.

It may be desirable in some cases to pre-spray the substrate 106 with water to increase its water content during the coating process. Pre-spraying may compensate for moisture that may be lost from the substrate during the heating and coating process, making the substrate softer, more flexible, and less brittle so as to increase workability during the coating and subsequent processes.

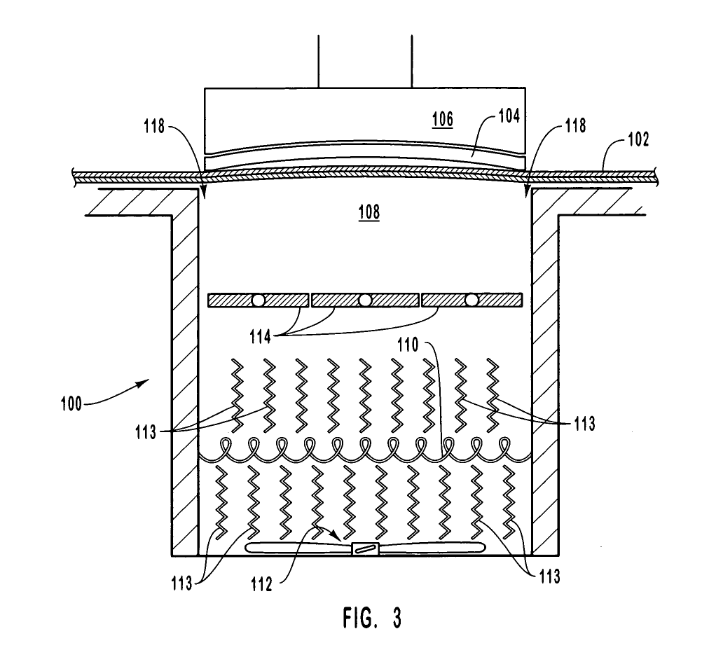

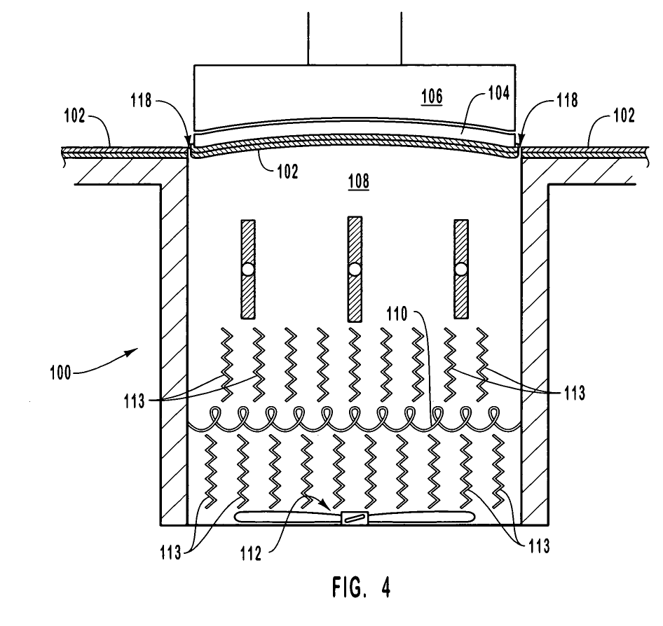

As further illustrated in FIG. 3, the molded substrate 104 is moved by suction member 106 so as to make contact with the inner layer 102a of the laminate sheet 102. A slight pressure may optionally be supplied by downward movement of the substrate 104 against the sheet 102 in order to cause some stretching and tension within laminate sheet 102 around outer periphery of molded substrate 104. Once substrate 104 contacts laminate sheet 102 and forms an appropriate seal with laminate sheet 102 around its perimeter, the suctioning force created by suction member 106 causes the laminate sheet 102 to be firmly suctioned against the surface of the molded substrate 104. The softened inner layer 102a causes the laminate coating to adhere to the molded substrate 104 (FIG. 4). In the case where molded substrate 104 is substantially cooler than multi-layer laminate 102, contacting the multi-layer laminate 102 to substrate 104 may cause sudden cooling (i.e., quenching) of the soft polymer of inner layer 102a. Such quenching causes almost immediate solidification and adhesion of the soft polymer to the substrate.

As shown in FIG. 4, when it is desired to trim excess laminate coating 102 from beyond the periphery of the molded article 104, louvers 114 may be opened in order to permit a sudden increase in the temperature and/or volume of heated air that is directed by heating cavity 108 toward the coated substrate. As illustrated in FIGS. 2-4, the suction member 106 is slightly smaller than the heating cavity 108. This creates a gap 118 around the perimeter of the molded substrate 104 through which heated air can preferentially flow when the louvers 114 are opened. Heated air moving toward and through the gap 118 preferentially melts and severs the laminate coating 102 around the perimeter of the substrate 104, thus trimming away excess laminate coating 102 from the coated article. The moving heated air may also cause any excess laminate sheet 102 that is present in the region of gap 118 to be blown up and around the edge of the substrate 104, thereby providing a smoother transition of laminate sheet 102 at the edge of substrate 104. After trimming, the louvers 114 can be closed and/or the fan 112 or heating element 110 deactivated in order to prevent overheating of the outer layer 102b of the laminate coating 102. Overheating the outer layer 102b is wasteful, may cause ripping or tearing of the laminate film, or may result in stacked laminated articles that undesirably adhere together.

A wax or similar coating may subsequently be applied (e.g., by spraying) to the reverse surface of substrate 104 where only a portion of the substrate has been coated with the multi-layer laminate. Scrap substrate, film, and wax overspray may be recycled.

### V. Characteristics of Laminated Articles

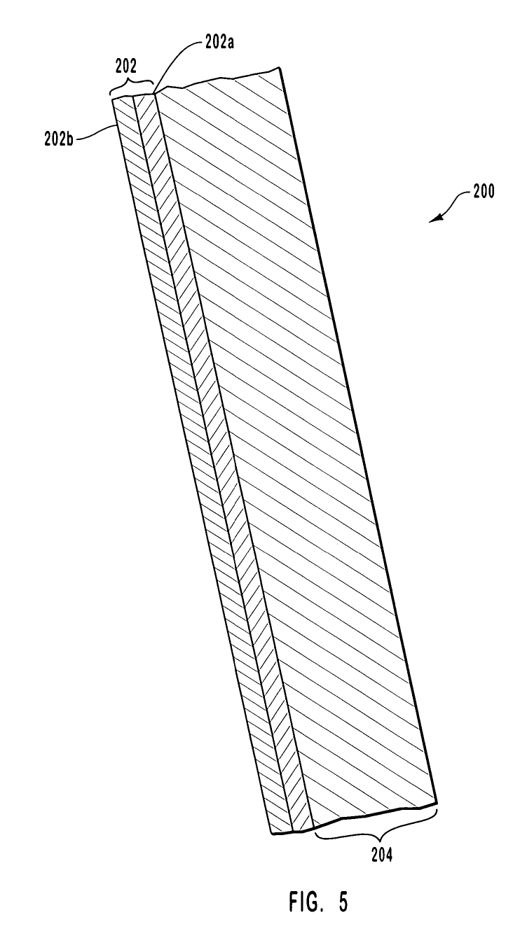

FIG. 5 schematically illustrates a cross sectional view of an exemplary laminated article or substrate 200 according to the invention. The article 200 includes a molded substrate 204 to which a laminate film or sheet coating 202 is attached. Laminate coating 202 provides resistance to moisture or other environmental forces and helps maintain a desired amount of moisture within the foam starch substrate prior to use (e.g., so as to increase flexibility and durability). Laminate coating 202 includes an inner layer 202a oriented toward molded article 204 and an outer layer 202b oriented away from molded article 204. The melting or softening temperature of at least one polymer within the inner layer 208a is lower than the melting or softening temperature of at least one polymer within the outer layer 208b.

As mentioned above, the multi-layer laminate coating 202 is integrally bonded to the substrate 204, such that if an attempt is made to pull the multi-layer laminate coating 202 away from the substrate 204, the break will typically not occur at the bond interface. Instead, the break will occur internal to the coating 202 and/or substrate 204 (i.e., the integral bond is stronger than the internal cohesion of the coating and the internal cohesion of the substrate).

### VI. Examples

### Example 1

A molded substrate comprising paperboard was formed. A two-layer laminate including an inner layer comprising about 95% ECOFLEX F, 4% ECOFLEX AB-1, and 1% ECOFLEX SL-1, and an outer layer formed of BIOMAX 4026 was formed. The inner layer comprised about 45% of the laminate while the BIOMAX 4026 outer layer comprised about 55% of the laminate. The melting temperature of the inner layer was about 110-120° C. The melting temperature of the BIOMAX 4026 outer layer was about 195° C. The multi-layer laminate was heated to a temperature between the melting temperature of the inner layer and the melting temperature of the outer layer and the two-layer laminate was adhered to the molded substrate. The multi-layer laminate had a moisture vapor transmission rate (MVTR) range between about 0-10 g/100 in²/day, with a nominal MVTR of about 5 g/100 in 2/day. The laminated article exhibited good moisture resistance, flexibility, and durability.

### Example 2

A molded substrate comprising paperboard was formed. A three-layer laminate blown film including an inner layer comprising about 22% ECOFLEX AB-3 and 78% ECOFLEX F, an adjacent central layer comprising about 22% ECOFLEX AB-3 and 78% ECOFLEX F, and an outer layer comprising about 3% ECOFLEX AB-3 and 97% PLA 4042D was formed. The inner layer comprised about 25% of the laminate, the central layer comprised about 35% of the laminate, while the outer layer comprised about 40% of the laminate. The melting temperature of the inner layer was between 110-115° C. The melting temperature of the outer layer was about 135° C. The multi-layer laminate was heated to a temperature between the melting temperature of the inner layer and the melting temperature of the outer layer and the three-layer laminate was adhered to the molded substrate. The laminated article exhibited good moisture resistance, flexibility, and durability.

### Example 3

A molded substrate comprising paperboard was formed. A three-layer laminate blown film including an inner layer comprising about 89% ECOFLEX F, 4% ECOFLEX AB-1 and 7% ECOFLEX SL-2, an adjacent central layer formed of ECOFLEX F, and an outer layer formed of PLA 4042D was formed. The inner layer comprised about 30% of the laminate, the central layer comprised about 30% of the laminate, while the outer layer comprised about 40% of the laminate. The melting temperature of the inner layer was between 110-120° C. The melting temperature of the outer layer was about 135° C. The multi-layer laminate was heated to a temperature between the melting temperature of the inner layer and the melting temperature of the outer layer and the three-layer laminate was adhered to the molded substrate. The multi-layer laminate had a moisture vapor transmission rate (MVTR) range between about 0-10 g/100 in²/day, with a nominal MVTR of about 5 g/100 in²/day. The laminated article exhibited good moisture resistance, flexibility, and durability.

### Example 4

A molded substrate comprising about 80% potato starch and about 20% wheat starch is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the melting temperature of the outer layer and the two-layer laminate is adhered to the molded substrate. The laminated article exhibits good moisture resistance, flexibility, and durability.

### Example 5

A molded substrate comprising about 50% potato starch and about 50% tapioca starch is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the melting temperature of the outer layer and the two-layer laminate is adhered to the molded substrate. The laminated article exhibits good moisture resistance, flexibility, and durability.

### Example 6

A molded substrate comprising 100% corn starch is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the outer layer and the melting temperature of the outer layer and the two-layer laminate is adhered to the molded substrate. The laminated article exhibits good moisture resistance, flexibility, and durability.

### Example 7

A molded substrate comprising 100% wheat starch is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the melting temperature of the outer layer and the two-layer laminate is adhered to the molded substrate. The laminated article exhibits good moisture resistance, flexibility, and durability.

### Example 8

A molded substrate comprising a cellulose ether is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the melting temperature of the outer layer and the two-layer laminate is adhered to the molded substrate. The laminated article exhibits good moisture resistance, flexibility, and durability.

### Example 9

A molded substrate comprising a polysaccharide is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the melting temperature of the outer layer and the two-layer laminate is adhered to the molded substrate. The laminated article exhibits good moisture resistance, flexibility, and durability.

### Example 10

A molded substrate comprising a protein is formed. A two-layer laminate including an inner layer comprising ECOFLEX and an outer layer formed of BIOMAX is formed. The melting temperature of the inner layer is between 110-120° C. The melting temperature of the outer layer is about 195° C. The multi-layer laminate is heated to a temperature between the melting temperature of the inner layer and the melting temperature of the outer layer and the two-layer laminate is adhered to the molded substrate. The laminated article exhibits good moisture resistance, flexibility, and durability.

### Comparative Example 11

A molded substrate comprising 100% potato starch was formed. A two-layer CD laminate including an inner layer comprising EASTARBIO and an outer layer formed of BIOMAX was formed. The melting temperature of the inner layer was about 108° C. The melting temperature of the outer layer was about 195° C. The multi-layer laminate was heated to a temperature between the melting temperature of the inner layer and the melting temperature of the outer layer and the two-layer laminate was adhered to the molded substrate. The EASTARBIO was observed to absorb ambient moisture and undergo heat induced hydrolysis during heating of the multi-layer laminate. In addition, the potato starch substrate was found to have lower than desirable and non-uniform porosity, resulting in a undesirably weak bond between the multi-layer laminate and the potato starch substrate.

### Comparative Example 12

A molded substrate comprising about 80% potato starch and about 20% corn starch was formed. A two-layer laminate including an inner layer comprising ECOFLEX and an outer layer formed of BIOMAX was formed. The melting temperature of the inner layer was about 110-120° C. The melting temperature of the outer layer was about 195° C. The multi-layer laminate was heated to a temperature between the melting temperature of the inner layer and the melting temperature of the outer layer and the two-layer laminate was adhered to the molded substrate. The ECOFLEX was observed to be less susceptible to absorption of ambient moisture than the EASTARBIO of the above Comparative Example. Heat induced hydrolysis during heating of the multi-layer laminate was not a significant concern. The potato/corn mixed starch substrate was found to have more uniform and higher porosity, resulting in a relatively stronger bond between the multi-layer laminate and the mixed starch substrate. The laminated article exhibited good moisture resistance, flexibility, and durability.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a laminated article, comprising:
(a) providing a porous or moisture-sensitive substrate;
(b) heating a multi-layer laminate sheet or film having inner and outer layers so as to substantially uniformly soften or melt the inner layer so as to render it adhesive to the substrate but not so high as to soften the outer layer to the point of destroying the physical integrity of the multi-layer laminate sheet or film,
the inner layer comprising at least one soft thermoplastic polymer having a melting or softening temperature;
the outer layer comprising at least one hard thermoplastic polymer having a melting or softening temperature that is greater than the melting or softening temperature of the soft thermoplastic polymer in the inner layer;
(c) orienting the multi-layer laminate sheet or film so that the inner layer faces toward, and the outer layer faces away from, the substrate; and
(d) contacting the inner layer of the multi-layer laminated sheet with at least a portion of the substrate in order to adhere the laminate sheet or film to the substrate and thereby form a laminated article.

2. A method as recited in claim 1, further comprising trimming excess multi-layer laminate sheet or film extending beyond an outer periphery of the laminated article.

3. A method as recited in claim 2, the excess multi-layer laminate sheet being trimmed by applying heat near the outer periphery of the laminated article.

4. A method as recited in claim 2, wherein the step of trimming excess multi-layer laminate sheet produces a laminated article having a substantially uniform edge.

5. A method as recited in claim 1, wherein the inner layer of the multi-layer laminate sheet or film comprises a material and/or is formed in a manner so as to substantially prevent heat induced hydrolysis of the inner layer of the multi-layer laminate.

6. A method as recited in claim 1, the inner layer of the laminate sheet or film being heated to a temperature that is between the melting or softening temperature of the at least one soft thermoplastic polymer within the inner layer and the melting or softening temperature of the at least one hard thermoplastic polymer within the outer layer.

7. A method as recited in claim 1, the porous or moisture-sensitive substrate being formed by shaping an aqueous composition comprising water and a water-dispersible organic polymer binder into a desired shape and removing at least a portion of the water by evaporation in order to at least partially dry and thereby solidify the water-dispersible organic polymer binder.

8. A method as recited in claim 7, wherein the removal of at least a portion of the water by evaporation causes the water-dispersible organic polymer binder to foam as it dries.

9. A method as recited in claim 1, wherein the step of contacting the inner layer of the multi-layer laminate sheet with at least a portion of the substrate comprises applying a vacuum through the substrate so as to at least assist the inner layer of the multi-layer laminate sheet in contacting and adhering to the substrate.

10. A method as recited in claim 1, wherein the step of contacting the inner layer of the multi-layer laminate sheet with at least a portion of the substrate comprises pressing the substrate against the multi-layer laminate so as to at least assist the inner layer of the multi-layer laminate sheet in contacting and adhering to the substrate.

11. A method as recited in claim 1, wherein the step of contacting the inner layer of the multi-layer laminate sheet with at least a portion of the substrate comprises applying a vacuum through the substrate and pressing the substrate against the multi-layer laminate so as to assist the inner layer of the multi-layer laminate sheet in contacting and adhering to the substrate.

12. A laminated article manufactured according to the method of claim 1.

13. A laminated article of manufacture, comprising:
a porous or moisture-sensitive molded substrate; and
a multi-layer laminate film or sheet coating on at least a portion of the molded substrate, the multi-layer laminate comprising:
an inner layer oriented so as to face the molded substrate and comprising at least one soft thermoplastic polymer having a melting or softening temperature and that does not undergo significant heat induced hydrolysis when formed into a film or sheet; and
an outer layer oriented so as to face away from the molded substrate and comprising at least one hard thermoplastic polymer having a melting or softening temperature that is greater than the melting or softening temperature of the soft thermoplastic polymer of the inner layer.

14. An article of manufacture as recited in claim 13, wherein the porous or moisture-sensitive substrate comprises at least one of paper, paperboard, or a molded pulp.

15. An article of manufacture as recited in claim 13, wherein the porous or moisture-sensitive substrate comprises at least one of a starch, a cellulose ether, a protein, or a polysaccharide gum.

16. An article of manufacture as recited in claim 13, wherein the porous or moisture-sensitive substrate comprises potato starch and at least one other starch.

17. An article of manufacture as recited in claim 13, wherein the porous or moisture-sensitive substrate comprises at least one starch selected from the group consisting of corn starch, waxy corn starch, rice starch, tapioca starch, wheat starch, their grain predecessors, and their modified counterparts.

18. An article of manufacture as recited in claim 13, wherein the outer layer of the multi-layer laminate coating comprises at least of one of a modified polyethylene terephthalate based biodegradable polyester having a melting or softening temperature greater than about 120° C. or polylactic acid (PLA).

19. An article of manufacture as recited in claim 13, wherein the inner layer of the multi-layer laminate coating comprises an aliphatic-aromatic co-polyester having a melting or softening temperature less than about 120° C.

20. An article of manufacture as recited in claim 19, wherein the inner layer of the multi-layer laminate coating comprises a branched aliphatic-aromatic co-polyester having a melting or softening temperature less than about 120° C.

21. An article of manufacture as recited in claim 13, wherein the at least one hard thermoplastic polymer used to make the outer layer of the multi-layer laminate coating has a melting or softening temperature that is at least about 10° C. greater than the melting or softening temperature of the at least one soft thermoplastic polymer used the make the inner layer.

22. An article of manufacture as recited in claim 13, wherein the at least one hard thermoplastic polymer used to make the outer layer of the multi-layer laminate coating has a melting or softening temperature that is at least about 20° C. greater than the melting or softening temperature of the at least one soft thermoplastic polymer used the make the inner layer.

23. An article of manufacture as recited in claim 13, wherein the at least one hard thermoplastic polymer used to make the outer layer of the multi-layer laminate coating has a melting or softening temperature that is at least about 50° C. greater than the melting or softening temperature of the at least one soft thermoplastic polymer used the make the inner layer.

24. A laminate article of manufacture, comprising:
a porous or moisture sensitive molded substrate; and
a multi-layer laminate film or sheet coating on at least a portion of the molded substrate, the multi-layer laminate coating comprising:
an inner layer oriented so as to face the molded substrate and comprising at least one type of soft branched aliphatic-aromatic copolyester that is resistant to moisture absorption and that has a melting or softening temperature less than about 120° C.; and
an outer layer oriented so as to face away from the molded substrate and comprising at least one type of hard thermoplastic polymer having a melting or softening temperature greater than about 150° C.

25. A foam starch laminate article of manufacture, comprising:
a porous or moisture sensitive foam substrate comprising at least one starch selected from the group consisting of corn starch, waxy corn starch, rice starch, tapioca starch, wheat starch, their grain predecessors, and their modified counterparts; and
a multi-layer laminate film or sheet coating on at least a portion of the foam substrate, the multi-layer laminate coating comprising:
an inner layer oriented so as to face the foam substrate and comprising at least one soft thermoplastic polymer having a melting or softening temperature; and
an outer layer oriented so as to face away from the foam substrate and comprising at least one hard thermoplastic polymer having a melting or softening temperature that is greater than the melting or softening temperature of the soft thermoplastic polymer of the inner layer.
